(19) United States
(12) Patent Application Publication
(10) Pub. No.: US 2026/0008214 A1
(43) Pub. Date: Jan. 8, 2026

(54) DRIVE MECHANISM FOR SCREW OF INJECTION CYLINDER, INJECTION UNIT AND INJECTION MOLDING MACHINE PROVIDED WITH THE DRIVE MECHANISM, AND METHOD FOR MANUFACTURING THE DRIVE MECHANISM

(71) Applicant: THE JAPAN STEEL WORKS, LTD., Tokyo (JP)

(72) Inventor: Keisuke KIMURA, Tokyo (JP)

(21) Appl. No.: 19/260,957

(22) Filed: Jul. 7, 2025

(30) Foreign Application Priority Data
Jul. 8, 2024 (JP) 2024-109397

(51) Int. Cl. B29C 45/50

(52) U.S. Cl. CPC B29C 45/5008; B29C 2045/5052

(57) ABSTRACT

The drive mechanism for a screw of an injection cylinder comprises a front plate that includes a through hole and that is connected to the injection cylinder, a movable plate that rotatably supports the screw, a ball nut that is installed in the movable plate, a ball screw that engages with the ball nut and that drives the movable plate in the axial direction of the screw, a bearing that is installed in the through hole and that rotatably supports the ball screw, a support nut that is screwed into the end of the through hole on the opposite side of the front plate from the ball nut, and bolts that are supported by the support nut. The support nut includes threaded holes that are arranged circumferentially and that pass through the support nut in the axial direction. The bolts protrude from the threaded holes to press the thrust bearing.

### FIELD

This application claims the benefit of Japanese Priority Patent Application No. JP 2024-109397 filed on July 8, 2024, the entire contents of which are incorporated herein by reference. This invention relates to a drive mechanism for a screw of an injection cylinder, an injection unit and an injection molding machine provided with the drive mechanism, and to a method for manufacturing the drive mechanism.

### BACKGROUND

An injection unit of an injection molding machine comprises a drive mechanism for a screw. Japanese Patent Application Laid-Open No. 2023- 71233 describes a drive mechanism comprising a front plate that is connected to an injection cylinder, and a movable plate that rotatably supports the screw. Bearings are provided in the front plate, and ball screws are rotatably supported by the bearings. Ball nuts are installed in the movable plate. Rotation of the ball screws move the ball nuts, which drive the movable plate and the screw supported by the movable plate in the axial direction of the screw.

### SUMMARY

The front plate receives an axial reaction force from the injection cylinder during injection. For this reason, thrust bearings are used as bearings to support the ball screws. To ensure that the thrust bearings properly receive the reaction force, a preload is sometimes applied to the thrust bearings. The preload can be applied by pushing the thrust bearings with the nuts, but a large torque is required to tighten the nuts, a special tool is necessary.

The purpose of the present disclosure is to provide a drive mechanism for a screw that allows easy preloading of the thrust bearing provided in the front plate.

The drive mechanism for the screw of the injection cylinder of the present disclosure comprises a thrust bearing that is installed in a through hole in a front plate and that rotatably supports a ball screw that engages with a ball nut, and a support nut that is screwed into the end of the through hole on the opposite side of the front plate from the ball nut, and a plurality of bolts that are supported by the support nut. The support nut includes a plurality of threaded holes that are arranged circumferentially and that pass through the support nut in the axial direction. The plurality of bolts engage with the plurality of threaded holes and protrude from the plurality of threaded holes to press the thrust bearing in the axial direction.

### BRIEF DESCRIPTION OF THE DRAWINGS

The above features and advantages of the present invention will become more apparent based on the following description of certain preferred embodiments taken in conjunction with the accompanying drawings, in which:

FIG. 1 is a schematic front view of an injection molding machine according to a first embodiment;

Fog. 2 is a top view of the injection unit of the injection molding machine shown in FIG. 1;

FIG. 3 is an enlarged view of area A shown in FIG. 2;

FIG. 4 is an enlarged view of area B shown in FIG. 3;

FIG. 5 is a front view of the support nut viewed from the X-direction;

FIG. 6 is a diagram similar to showing a nut in a comparative example;

FIG. 7 is a diagram similar to FIG. 4 showing a mold-clamping unit of an injection molding machine according to a second embodiment; and

FIG. 8 is a diagram similar to FIG. 4 showing a mold-clamping unit of an injection molding machine according to a third embodiment.

### DETAILED DESCRIPTION

Embodiments of the present invention are described below with reference to the drawings. In the following description and drawings, the axial direction of the injection cylinder and the screw is referred to as the X-direction. The X-direction is parallel to the horizontal direction. The direction from the injection unit to a mold-clamping unit and an injection direction of a material to be injected is referred to as the +X-direction. The direction from the mold- clamping unit to the injection unit is referred to as the -X-direction. The vertical direction is referred to as the Z-direction.

### First Embodiment

### Overall Configuration

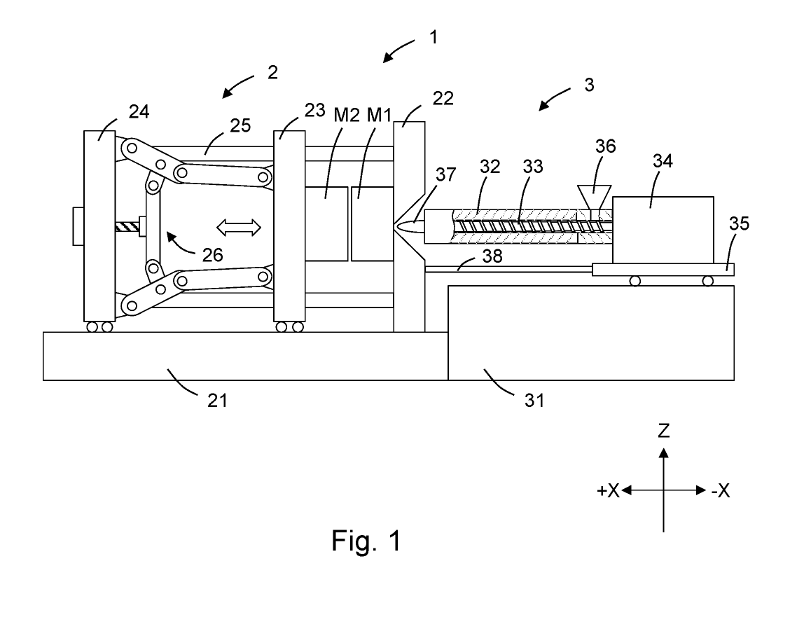

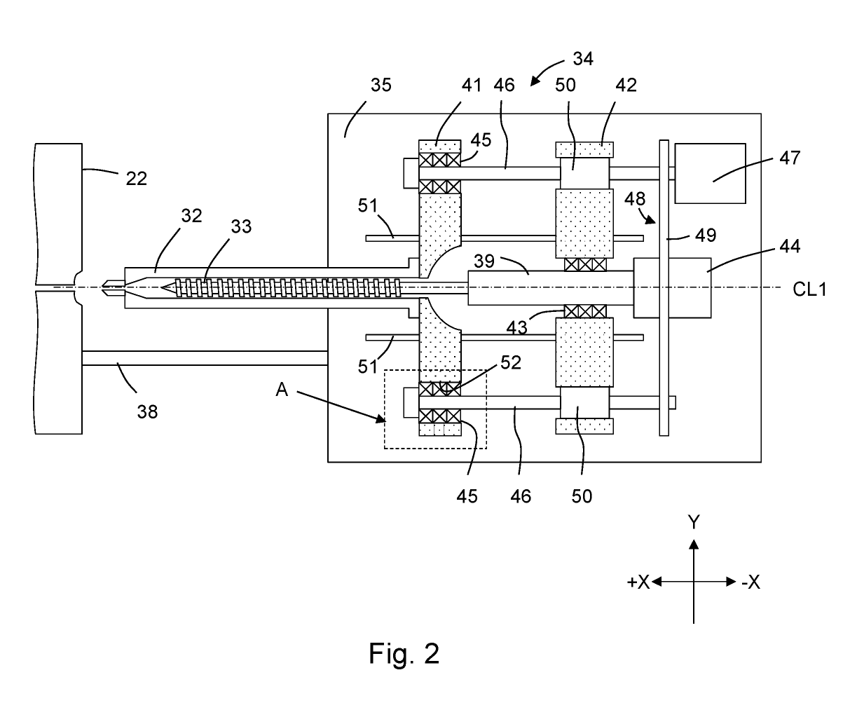

FIG. 1 shows a schematic front view of injection molding machine 1 according to the first embodiment. Injection molding machine 1 generally comprises mold-clamping unit 2 that secures the mold and that opens and closes the mold, and injection unit 3 that heats and melts a material to be injected and that injects the material.

### Mold-Clamping Unit 2

Mold-clamping unit 2 comprises fixed platen 22 that is fixed on bed 21 and to which fixed mold M1 is attached, mold-clamping housing 24 that can slide on bed 21, and movable platen 23 that can slide on bed 21 and to which movable mold M2 is attached. Fixed platen 22 and clamping housing 24 are connected by a plurality of tie bars 25. Mold-clamping mechanism 26 is provided between movable platen 23 and mold-clamping housing 24 for opening and closing the mold. Mold-clamping mechanism 26 is configured as a toggle mechanism but may also be configured as a hydraulic mold-clamping cylinder.

### Injection Unit 3

Injection unit 3 is provided on base 31. Injection unit 3 comprises injection cylinder 32, screw 33 that is housed in injection cylinder 32, drive mechanism 34 that drives screw 33, and support plate 35 that supports drive

mechanism 34. Drive mechanism 34 rotates and drives screw 33 in the X- direction. Hopper 36, which supplies material to be injected, is provided near the end of injection cylinder 32 in the -X-direction. Injection nozzle 37, which injects the material, is provided at the end of injection cylinder 32 in the +X-direction.

### Nozzle Touch Device 38

Injection unit 3 comprises nozzle touch device 38. Nozzle touch device 38 connects support plate 35 and fixed platen 22. Nozzle touch device 38 is configured, for example, as a mechanism that uses a hydraulic cylinder or a mechanism that uses ball screws. Nozzle touch device 38 drives support plate 35 in the X-direction, whereby injection nozzle 37 touches a sprue bushing (not shown) of the mold.

### Drive Mechanism 34 of Injection Unit 3

FIG. 2 shows a top view of injection unit 3. Drive mechanism 34 of screw 33 comprises front plate 41 that supports injection cylinder 32 and movable plate 42 that is located on the -X-direction side of front plate 41. Front plate 41 and movable plate 42 are supported by support plate 35. Support part 39 of screw 33 is connected to the end of screw 33 in the -X-direction, and support part 39 is rotatably supported by movable plate 42 via bearings 43. Thus, screw 33 is rotatably supported on movable plate 42 via support part 39.

Drive mechanism 34 comprises plasticizing motor 44 that is provided on support plate 35 and a rotation transmission mechanism (not shown). The rotation transmission mechanism comprises pulleys that are connected to plasticizing motor 44, a timing belt that is wound around the pulleys, and the like. Plasticizing motor 44 rotates and drives support part 39 through the rotary transmission mechanism, whereby plasticizing motor 44 rotates and drives screw 33.

Drive mechanism 34 comprises two ball screws 46 that are supported on front plate 41 via bearings 45, injection motor 47 that is provided on support plate 35, and rotation transmission mechanism 48. Two ball screws 46 are provided, one on each side of central axis CL of injection cylinder 32 when viewed in the Z-direction. Rotation transmission mechanism 48 comprises pulleys (not shown) that are connected to injection motor 47, and timing belt 49 that is wound around the pulleys. Timing belt 49 is wound around the pulleys of the two ball screws 46. Injection motor 47 drives the two ball screws 46 at the same rotational speed by means of rotational transmission mechanism 48.

Ball nuts 50, which engage with ball screws 46, are installed in movable plate 42. Since ball screws 46 are fixed at positions relative to front plate 41 in the X-direction, rotation of ball screws 46 causes ball nuts 50 to move in the X-direction along ball screws 46. As a result, ball screws 46 drive movable plate 42 in the X-direction as well as screw 33 that is supported by movable plate 42. Movable plate 42 can move in the X-direction while being guided by guide rails 51 on support plate 35.

### Support Structure of Bearing 45

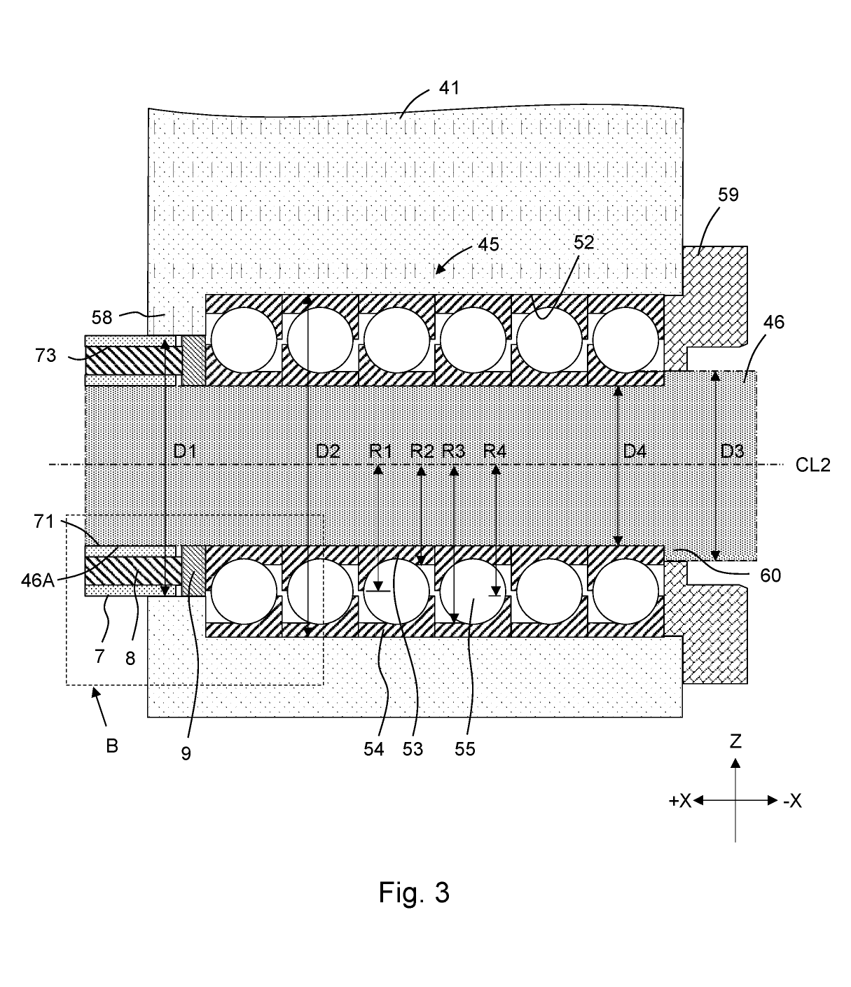

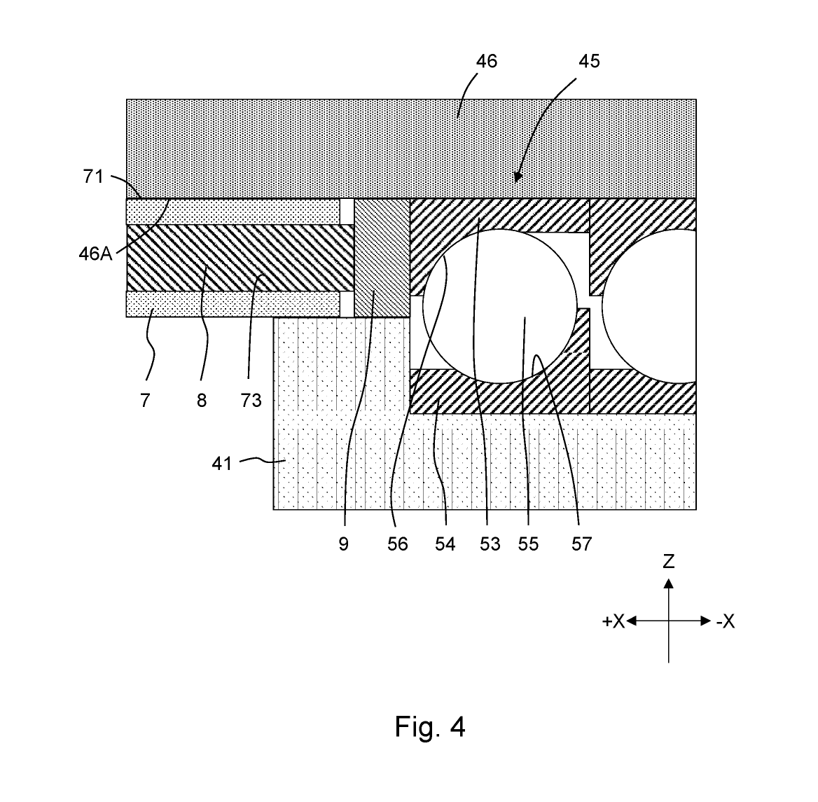

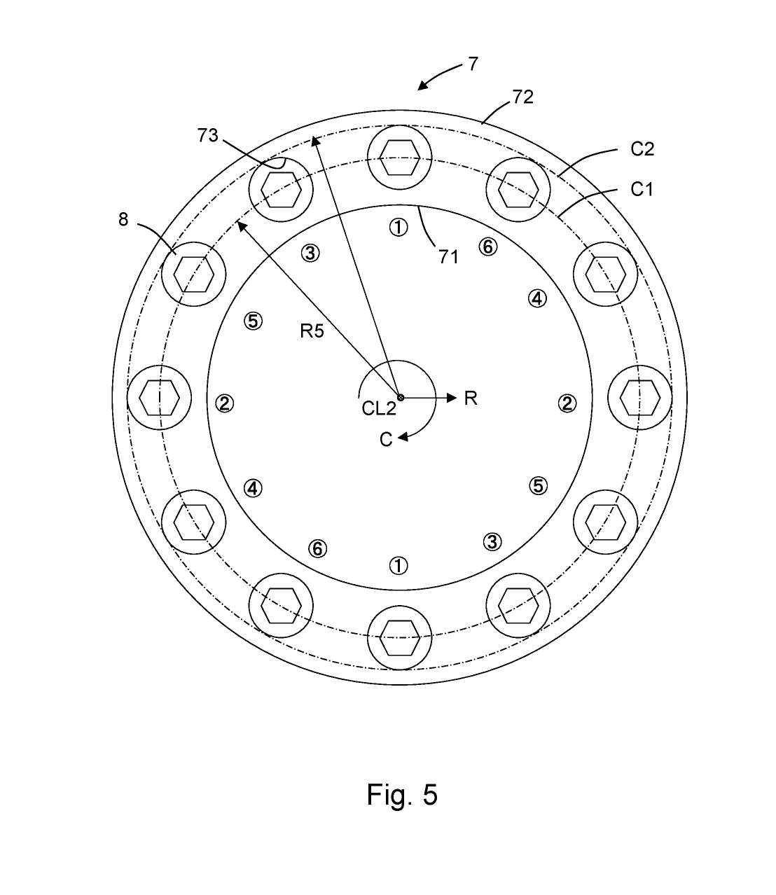

FIG. 3 shows an enlarged view of area A shown in FIG. 2 and shows the structure of bearing 45 and the surrounding area. FIG. 4 shows an enlarged view of area B shown in FIG. 3, and FIG. 5 shows a front view of support nut 7 viewed from the X-direction. As shown in FIG. 5, radial direction R is toward or away from central axis CL2 of ball screw 46, and circumferential direction C is around central axis CL2 of ball screw 46.

Front plate 41, which is connected to injection cylinder 32, comprises through holes 52 in which bearings 45 are installed. Bearings 45, which are supported in through holes 52, rotatably support ball screws 46. The number of bearings 45 is not limited, and at least one bearing 45 should be provided. During injection, injection cylinder 32 receives a reaction force in the -X- direction, which is transmitted to front plate 41 and bearing 45 in the -X direction. Therefore, bearing 45 is configured to be a thrust bearing.

Bearing 45 comprises inner ring 53, outer ring 54, and balls 55 that are located between inner ring 53 and outer ring 54. As shown in FIG. 4, each inner ring 53 includes groove 56 and each outer ring 54 includes groove 57, and these grooves accommodate balls 55. The radial tip of each inner ring 53 on the +X-direction side protrudes further toward a respective outer ring 54 than the radial tip of that inner ring 53 on the -X-direction side. The radial tip of each outer ring 54 on the -X-direction side protrudes further toward a respective inner ring 53 than the radial tip of that outer ring 54 on the +X-direction side. As shown in FIG. 3, if the distance from center axis CL2 of ball screw 46 to the radial tip of each inner ring 53 on the +X-direction side is R1, and the distance from center axis CL2 of ball screw 46 to the radial tip of each inner ring 53 on the -X- direction side is R2, then R1 > R2. If the distance from center axis CL2 of ball screw 46 to the radial tip of each outer ring 54 on the +X-direction side is R3 and the distance from center axis CL2 of ball screw 46 to the radial tip of each outer ring 54 on the -X-direction side is R4, then R3 > R4.

Front plate 41 comprises flange 58 that narrows the opening of the end of through hole 52 on the +X-direction side, and inner diameter D1 of flange 58 is smaller than inner diameter D2 of the area where bearing 45 is positioned. Cover member 59 that covers the end of through hole 52 on the -X-direction side is fixed to front plate 41 by bolts (not shown). Outer diameter D3 of ball screw 46 at cover member 59 is larger than outer diameter D4 of the area where bearing 45 is positioned. Bearing 45 is located between flange 58 and shoulder 60 of ball screw 46 and is pressed against shoulder 60 of ball screw 46 and cover member 59 by preloading of bearing 45 in the -X-direction as described below.

Support nut 7 is screwed into the end of through hole 52 that is on the opposite side of front plate 41 from ball nut 50 (the end on the +X-direction side). Specifically, an internal thread (not shown) is formed on the inner circumferential surface of through hole 52 (on flange 58) and an external thread (not shown) is formed on the outer circumferential surface of support nut 7, and support nut 7 is screwed into through hole 52 by causing these external and internal threads to engage. The side surface of hole 71 in support nut 7 is a smooth surface, and outer circumferential surface 46A of ball screw 46 is also a smooth surface.

As shown in FIGS. 4 and 5, support nut 7 includes a plurality of threaded holes 73 passing in the X-direction and arranged in the circumferential direction C between hole 71 and outer surface 72. The number of threaded holes 73 is not limited, but examples include 8, 10, 12, and 16. The plurality of threaded holes 73 are preferably arranged at equal intervals in circumferential direction C. The centers of the plurality of threaded holes 73 lie on circle C1 that is concentric with ball screw 46 (i.e., centered on central axis CL2). A plurality of bolts 8 are supported by support nut 7. Bolts 8 are hexagon socket head screws, but the type of bolts 8 is not limited to this form. As shown in FIG. 4, the plurality of bolts 8 engage with the plurality of threaded holes 73 and protrude from the plurality of threaded holes 73 in the -X-direction to press (preload) bearing 45 in the -X-direction.

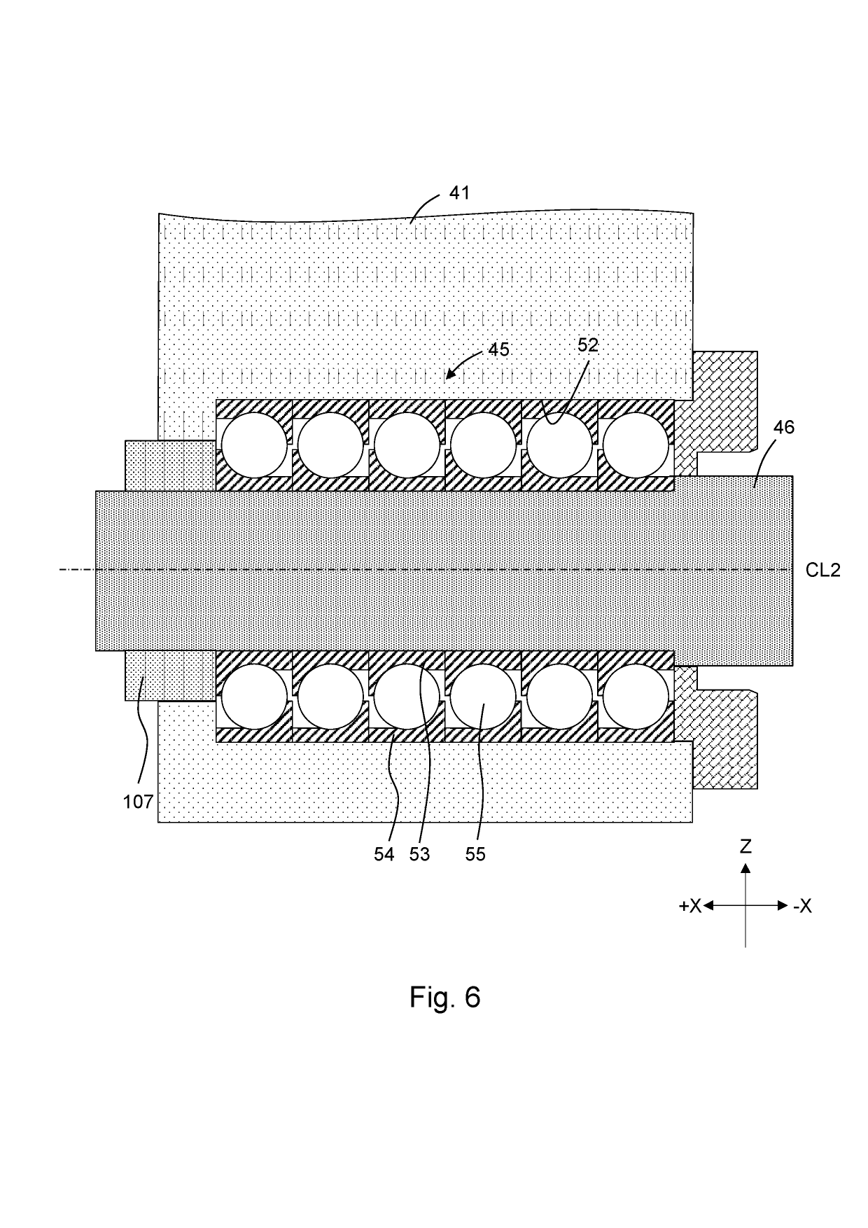

FIG. 6 is a diagram similar to FIG. 3 showing nut 107 in a comparative example. Nut 107 is an ordinary nut but is not provided with threaded holes 73. When preloading bearing 45 with nut 107 in the comparative example, nut 107 is screwed into through hole 52 until nut 107 comes into contact with inner ring 53 of bearing 45. However, this screwing operation is difficult due to the large tightening torque required, and a special tool is needed.

In the current embodiment, support nut 7 is first screwed into through hole 52. Support nut 7 does not have the function of preloading bearing 45 and only supports bolts 8 and is therefore positioned away from bearing 45 in the X- direction. Therefore, support nut 7 can be installed by, for example, rotating it by hand, and the tightening torque is significantly lower than that of nut 107 in the comparative example. Bolts 8 are screwed into threaded holes 73 of support nut 7. Since the tightening torque for each bolt 8 is sufficiently lower compared to nut 107 in the comparative example, an ordinary torque wrench can be used, and the operation is easy.

In order to apply uniform preloading to bearing 45, the tightening operation is preferably divided into several steps to tighten the bolts sequentially, starting with bolts 8 that are farther apart from each other. For example, in FIG. 5, two bolts 8 that are 180° apart (e.g., bolts 8 at the 12-o'clock and 6-o'clock positions on the clock) are provisionally tightened, then bolts 8 furthest from these two bolts 8 (e.g., bolts 8 at the 3-o'clock and 9-o'clock positions on the clock) are provisionally tightened, and following which the other bolts 8 are provisionally tightened in the same manner. Bolts 8 are next tightened to a specified tightening torque in the same order. The number of repetitions of the tightening process and the specified torque in each process can be determined as necessary. The circled numbers in the figure show an example of the order in which bolts 8 are to be tightened, but the procedure is not limited to this order.

As shown in FIGS. 3 and 4, to further apply uniform preloading to bearing 45, injection unit 3 comprises washer 9 that is located between the plurality of bolts 8 and bearing 45. Washer 9 is in contact with the plurality of bolts 8 and bearing 45. Washer 9 may be a ring with a hole through which ball screw 46 passes. Bolts 8 press against bearing 45 by way of washer 9 so that the pressure applied by bolts 8 is equalized by washer 9. Washer 9 may also be omitted.

### Second Embodiment

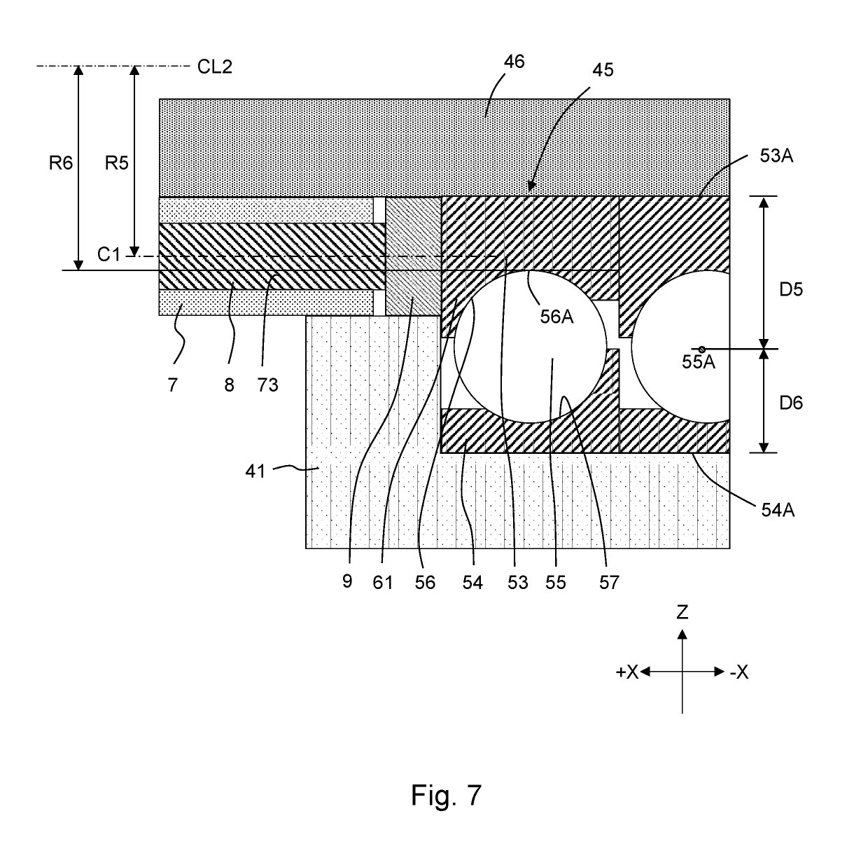

FIG. 7 is a diagram similar to FIG. 4 showing mold-clamping unit 2 of injection molding machine 1 according to a second embodiment. As described above, by tightening multiple bolts 8 with the same tightening torque, bearing 45 can be preloaded almost uniformly in circumferential direction C. However, the pressure may vary in circumferential direction C, whereby the pressure may be greater at certain positions in circumferential direction C of bearing 45. In particular, the application of great pressure to thin section 61 on the +X- direction side of inner ring 53 may increase the deformation of inner ring 53 and thus affect the operation of bearing 45.

In this embodiment, the dimension of inner ring 53 in radial direction R is enlarged compared to the first embodiment, whereby centers 55A of balls 55 are closer to outer circumferential surface 54A of outer ring 54 than inner circumferential surface 53A of inner ring 53 in radial direction R. In other words, distance D5 between centers 55A of balls 55 and inner circumferential surface 53A of inner rings 53 in radial direction R is greater than distance D6 between centers 55A of balls 55 and outer circumferential surface 54A of outer ring 54 in radial direction R. As a result, the pressure applied to thin section 61 of bearing 45 can be reduced and the deformation of inner ring 53 can also be reduced. Since radius R5 of circle C1 is smaller than distance R6 between the bottom of groove 56A and center axis CL2 of ball screw 46 in this embodiment, the center lines of bolts 8 do not coincide with thin section 61. Although washer 9 is illustrated in FIG. 7, washer 9 may be omitted as in the first embodiment.

### Third Embodiment

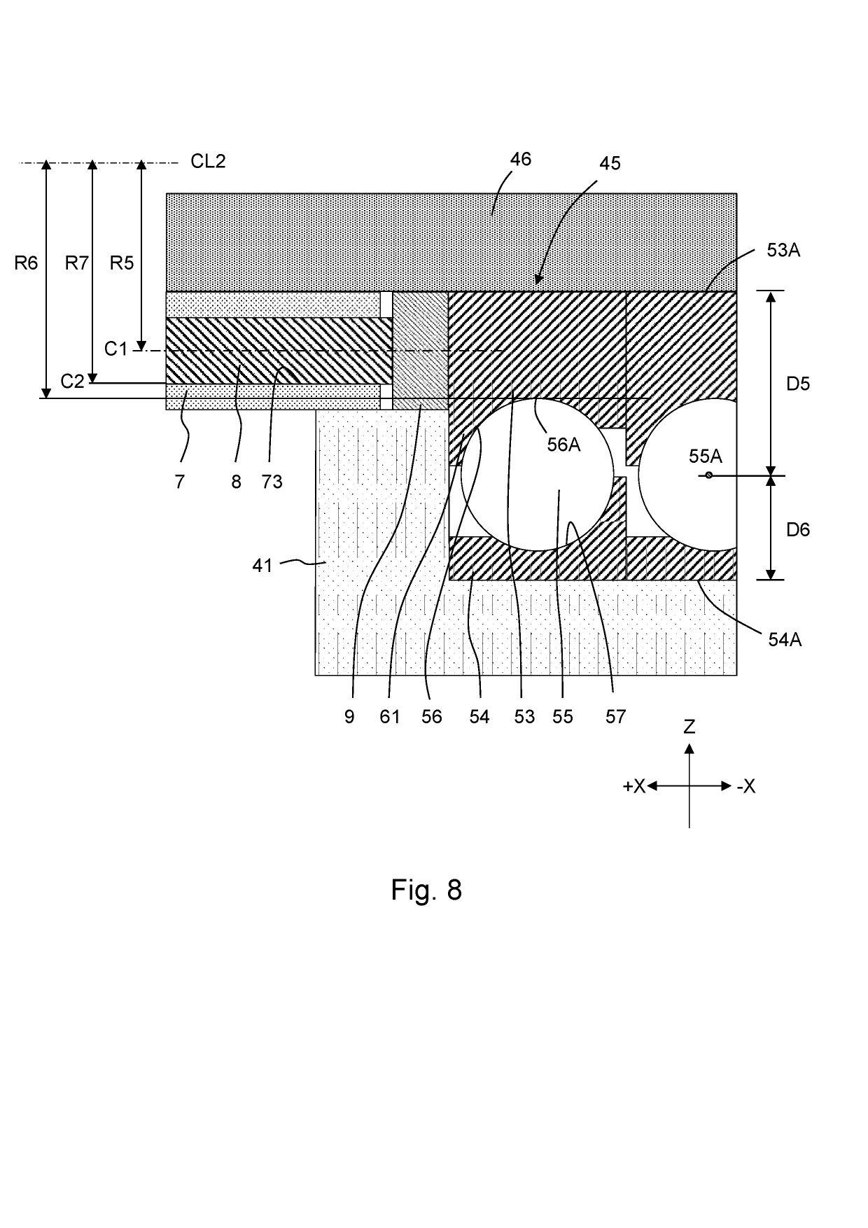

FIG. 8 is a diagram similar to FIG. 4 showing mold-clamping unit 2 of injection molding machine 1 according to a third embodiment. In this embodiment, as in the second embodiment, centers 55A of balls 55 are closer to outer circumferential surface 54A of outer ring 54 than inner circumferential surface 53A of inner ring 53. As in the second embodiment, radius R5 of circle C1 is smaller than distance R6 between bottom 56A of groove 56 and central axis CL2 of ball screw 46. As in the second embodiment, this configuration allows a further reduction of the deformation of inner ring 53 in this embodiment. Furthermore, in this embodiment, since radius R7 of smallest circle C2 (see FIG. 5) that contains the plurality of threaded holes 73 is smaller than distance R6 between bottom 56A of groove 56 and central axis CL2 of ball screw 46, the entirety of bolts 8 does not coincide with thin section 61. Although washer 9 is illustrated in FIG. 8, washer 9 may be omitted as in the first embodiment.

Although the invention has been described above in connection with several preferred embodiments thereof, it will be understood by those skilled in the art that these embodiments are provided solely for illustrating the invention and do not limit the scope of the appended claims.

### LIST OF REFERENCE NUMERALS

1 injection molding machine

3 injection unit

7 support nut

8 bolt

9 washer

32 injection cylinder

33 screw

34 drive mechanism for screw

41 front plate

42 movable plate

46 ball screw

45 bearing

50 ball nut

52 through hole

53 inner ring

54 outer ring

55 ball

73 threaded hole

1. A drive mechanism for a screw of an injection cylinder, comprising:
a front plate that includes a through hole and that is connected to said injection cylinder;
a movable plate that rotatably supports said screw housed in said injection cylinder;
a ball nut that is installed in said movable plate;
a ball screw that engages with said ball nut and that drives said movable plate in an axial direction of said screw;
a thrust bearing that is installed in said through hole and that rotatably supports said ball screw;
a support nut that is screwed into an end of said through hole on an opposite side of said front plate from said ball nut; and
a plurality of bolts that are supported by said support nut, wherein
said support nut includes a plurality of threaded holes that are arranged circumferentially and that pass through said support nut in the axial direction, and wherein
said plurality of bolts that engage with said plurality of threaded holes and that protrude from said plurality of threaded holes to press said thrust bearing in the axial direction.

2. The drive mechanism according to claim 1, further comprising washers that are located between said plurality of bolts and said thrust bearing and that are in contact with said plurality of bolts and said thrust bearing.

3. The drive mechanism according to claim 1, wherein
said thrust bearing comprises an inner ring, an outer ring, and balls that are located between said inner ring and said outer ring, and wherein
centers of said plurality of threaded holes are on a circle concentric with said ball screw, said inner ring includes a groove to accommodate said balls, and a radius of said circle is smaller than a distance between a bottom of said groove and a center axis of said ball screw.

4. The drive mechanism according to claim 3, wherein a radius of the smallest circle that contains said plurality of threaded holes is smaller than the distance between the bottom of said groove and the center axis of said ball screw.

5. The drive mechanism according to claim 3, wherein centers of said balls are closer to an outer circumference of said outer ring than to an inner circumference of said inner ring.

6. An injection unit comprising an injection cylinder, a screw that is housed in said injection cylinder, and a drive mechanism for said screw,
wherein said drive mechanism comprises:
a front plate that includes a through hole and that is connected to said injection cylinder;
a movable plate that rotatably supports said screw housed in said injection cylinder;
a ball nut that is installed in said movable plate;
a ball screw that engages with said ball nut and that drives said movable plate in an axial direction of said screw;
a thrust bearing that is installed in said through hole and that rotatably supports said ball screw;
a support nut that is screwed into an end of said through hole on an opposite side of said front plate from said ball nut; and
a plurality of bolts that are supported by said support nut, wherein
said support nut includes a plurality of threaded holes that are arranged circumferentially and that pass through said support nut in an axial direction, and wherein
said plurality of bolts that engage with said plurality of threaded holes and that protrude from said plurality of threaded holes to press said thrust bearing in the axial direction.

7. The injection unit according to claim 6, further comprising washers that are located between said plurality of bolts and said thrust bearing and that are in contact with said plurality of bolts and said thrust bearing.

8. The injection unit according to claim 6, wherein said thrust bearing comprises an inner ring, an outer ring, and balls that are located between said inner ring and said outer ring, and wherein centers of said plurality of threaded holes are on a circle concentric with said ball screw, said inner ring includes a groove to accommodate said balls, and a radius of said circle is smaller than a distance between a bottom of said groove and a center axis of said ball screw.

9. The injection unit according to claim 8, wherein a radius of the smallest circle that contains said plurality of threaded holes is smaller than the distance between the bottom of said groove and the center axis of said ball screw.

10. The injection unit according to claim 8, wherein centers of said balls are closer to an outer circumference of said outer ring than to an inner circumference of said inner ring.

11. An injection molding machine comprising:
an injection unit that comprises an injection cylinder, a screw that is housed in said injection cylinder, and a drive mechanism for said screw; and
a mold-clamping unit that supports a mold and that opens and closes said mold,
wherein said drive mechanism comprises:
a front plate that includes through hole and that is connected to said injection cylinder;
a movable plate that rotatably supports said screw housed in said injection cylinder;
a ball nut that is installed in said movable plate;
a ball screw that engages with said ball nut and that drives said movable plate in an axial direction of said screw;
a thrust bearing that is installed in said through hole and that rotatably supports said ball screw;
a support nut that is screwed into an end of said through hole that is on an opposite side of said front plate from said ball nut; and
a plurality of bolts that are supported by said support nut, wherein
said support nut includes a plurality of threaded holes that are arranged circumferentially and that pass through said support nut in the axial direction, and wherein
said plurality of bolts engage with said plurality of threaded holes and that protrude from said plurality of threaded holes to press said thrust bearing in the axial direction.

12. The injection molding machine according to claim 11, further comprising washers that are located between said plurality of bolts and said thrust bearing and that are in contact with said plurality of bolts and said thrust bearing.

13. The injection molding machine according to claim 11, wherein said thrust bearing comprises an inner ring, an outer ring, and balls that are located between said inner ring and said outer ring, and wherein the centers of said plurality of threaded holes are on a circle concentric with said ball screw, said inner ring includes a groove to accommodate said balls, and a radius of said circle is smaller than a distance between a bottom of said groove and a center axis of said ball screw.

14. The injection molding machine according to claim 13, wherein a radius of the smallest circle that contains said plurality of threaded holes is smaller than the distance between the bottom of said groove and the center axis of said ball screw.

15. The injection molding machine according to claim 13, wherein centers of said balls are closer to an outer circumference of said outer ring than to an inner circumference of said inner ring.

16. A method for manufacturing a drive mechanism for a screw of injection cylinder, wherein said drive mechanism comprises:
a front plate that includes through hole and that is connected to said injection cylinder;
a movable plate that rotatably supports said screw housed in said injection cylinder;
a ball nut that is installed in said movable plate;
a ball screw that engages with said ball nut and that drives said movable plate in an axial direction of said screw;
a thrust bearing that is installed in said through hole and that rotatably supports said ball screw;
a support nut that includes a plurality of threaded holes arranged in a circumferential direction and passing through in the axial direction; and
a plurality of bolts that are supported by said support nut, the method comprising steps of:
screwing said support nut into an end of said through hole that is on an opposite side of said front plate from said ball nut;
engaging said plurality of bolts with said plurality of threaded holes in said support nut screwed into said through hole; and
causing said plurality of bolts to protrude from said plurality of threaded holes to press said thrust bearing in said axial direction.
